(19) United States
(12) Patent Application Publication
(10) Pub. No.: US 2018/0282183 A1
(43) Pub. Date: Oct. 4, 2018

(54) MINIATURE CAPACITIVE DEIONIZATION DEVICES AND RELATED SYSTEMS AND METHODS

(71) Applicant: Atlantis Technologies, Dana Point, CA (US)

(72) Inventors: Patrick Michael Curran, Laguna Niguel, CA (US); Jacob Silverman, Lake Forest, CA (US); Ryan Gilmore, Dana Point, CA (US); Lukas Buell, San Clemente, CA (US)

(73) Assignee: Atlantis Technologies, Dana Point, CA (US)

(21) Appl. No.: 15/839,725

(22) Filed: Dec. 12, 2017

Related U.S. Application Data
(60) Provisional application No. 62/498,009, filed on Dec. 12, 2016.

(51) Int. Cl. C02F 1/469

(52) U.S. Cl. CPC C02F 1/4691; C02F 2103/02

(57) ABSTRACT

Miniature capacitive deionization devices and related systems and methods are generally described. The devices may be incorporated as part of a water treatment and process system. Humidifier systems comprising a humidifier unit and a capacitive deionization device fluidically coupled with the humidifier unit are also disclosed. For example, the miniature capacitive deionization devices may be incorporated into a point of use humidifier.

### RELATED APPLICATIONS

This application claims priority to U.S. Provisional Application No. 62/498,009, filed Dec. 12, 2016, which is incorporated herein by reference in its entirety.

### TECHNICAL FIELD

Devices, systems, and methods related to treating water by capacitive deionization are generally described.

### BACKGROUND

Humidifiers are widely utilized in homes and businesses in order to increase the relative humidity of the air inside a building. There are many different types of humidifiers and they each have a different mechanism for transforming liquid water into airborne vapors. However, all of these humidifying technologies face a similar problems. As the water evaporates, any dissolved solids that were present stay in the solution. Also, any biologicals that enter the water reservoir can multiply during operation and be dispersed into the air. Over time the concentration of minerals and biologicals in the remaining water will increase. Without proper maintenance, this leads to a buildup of salt and hardness that can be detrimental to the humidifier's effectiveness and increase chance that biologicals are put into air. The mineral issue is more prominent in certain areas of the country, such as the Southwest United States, where the salt content of municipal water is higher.

Various technologies have been suggested and/or implemented for humidifier deionization but all have limitations. The leading solution at this time is to insert ion exchange cartridges into the humidifier unit. The cartridges help prevent mineral buildup by reducing the concentration of low solubility hardness species in the water. These cartridges are eventually depleted at which point they are either discarded or sent back to the manufacturer. The ion exchange cartridges may also be used to desalinate the water, but they are expensive and can require frequent replacement. Very few other desalination/deionization technologies are feasible in this application because of the small footprint of a point of use humidifier.

Another common solution for this problem is to use previously deionized water when filling the humidifier unit. Many manufacturers will recommend utilizing bottled/distilled/reverse osmosis water because it often times has a much lower concentration of salts and minerals compared to tap water. This is especially true in certain parts of the country that suffer from high total dissolved solids (TDS) municipal water supplies. By utilizing previously deionized water, there will be fewer minerals entering the humidifier in the first place and the concentration will increase at a much slower rate. This is an effective, but extremely costly and inconvenient practice.

Alternative treatment devices such as reverse osmosis (RO) are impractical. Incorporating an RO unit into a humidifier is physically unfeasible, and adding an RO unit in front of the humidifier is cost prohibitive.

Accordingly, alternative solutions are desired.

### SUMMARY

Devices, systems, and methods related to capacitive deionization are generally described.

According to one or more embodiments, a miniature radial capacitive deionization device for use in treating an aqueous stream by capacitive deionization is provided. The device may comprise an inlet to receive an aqueous stream; an outlet for delivering a treated aqueous stream; one or more capacitors positioned within a housing and defining a flow path between and in fluid communication with the inlet and the outlet and configured to produce the treated aqueous stream. The total volume enclosed by the housing may be between 50 and 2000 cm³. The one or more capacitors may be arranged as a spiral or with the plurality of electrodes arranged as concentric cylinders. Each of the one or more capacitors may comprise: a first electrode; a first ion specific layer associated with the first electrode; a second electrode spaced apart from the first electrode; a second ion specific layer associated with the second electrode; and a dielectric spacer forming the flow path positioned between the first ion specific layer and the second ion specific layer and configured to receive a portion of the aqueous stream from the inlet and deliver a portion of the treated aqueous stream to the outlet.

According to one or more embodiments, a method of treating an aqueous stream is provided. The method may comprise: feeding water from a source of the water to a miniature radial capacitive deionization device enclosed within a housing having a volume between 50 and 2000 cm³; treating the water within the miniature radial capacitive deionization device to produce a treated water; and delivering the treated water to a reservoir or water processing unit.

According to one or more embodiments, a humidifier system is provided. The humidifier system may comprise a humidifier unit and a capacitive deionization device fluidically coupled with the humidifier unit.

According to one or more embodiments, a method for treating a water associated with a humidifier system is provided. The method may comprise: introducing a water stream to a capacitive deionization device; treating the water within the capacitive deionization device to produce a treated water; introducing the treated water to a humidifying unit; and humidifying a local atmosphere with the treated water by generating a water vapor or water mist with the humidifying unit.

According to one or more embodiments a system is provided. The system may comprise a humidifier unit; and a radial capacitive deionization unit fluidically coupled with the humidifier unit.

According to one or more embodiments a method is provided. The method may comprise operating a system comprising a humidifier unit and a radial capacitive deionization unit.

According to one or more embodiments a method is provided. The method may comprise treating a source of water in a radial capacitive deionization unit to produce a treated water; and delivering the treated water to a humidifier unit.

According to one or more embodiments a method is provided. The method may comprise delivering a source of water to a humidifier reservoir; and continuously treating the water through the means of recirculating the water through a radial capacitive deionization unit.

According to one or more embodiments a method is provided. The method may comprise delivering a source of water from a humidifier reservoir to a radial capacitive deionization unit; and treating the water in a radial deionization unit to produce a treated water; and delivering the treated water to a heating or vaporization unit within a humidification device.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A is a photocopy of a photograph showing a miniature spiral wound radial capacitive deionization device in a pre-assembled state, according to one or more embodiments;

FIG. 1B is a photocopy of a photograph showing a layered configuration of the materials of FIG. 1A for use in constructing a miniature spiral wound radial capacitive deionization device, according to one or more embodiments;

FIG. 1C is a photocopy of a photograph showing a manufacturing step of rolling the layered configuration of FIG. 1B into a spiral to form a miniature spiral wound radial capacitive deionization device, according to one or more embodiments;

FIG. 1D is a photocopy of a photograph showing a top view of the miniature spiral wound radial capacitive deionization device assembled as illustrated in FIG. 1C and without casing, according to one or more embodiments;

FIG. 1E is a photocopy of a photograph showing the miniature spiral wound radial capacitive deionization device of FIG. 1D within an outer casing with fluidic and electrical connections as configured for use, according to one or more embodiments;

FIG. 2 illustrates a spirally wound capacitor pair of a radial capacitive deionization device according to one or more embodiments;

FIG. 3 illustrates a radial cross-section of the spirally wound capacitor pair FIG. 3 according to one or more embodiments;

FIG. 4 shows a concentric cylinder layer radial capacitive deionization device, according to one or more embodiments;

FIG. 5 shows additional views of the concentric cylinder layer radial capacitive deionization device of FIG. 4, according to one or more embodiments;

FIG. 6 shows a detailed, cut-away view of a portion of the concentric cylinder layer radial capacitive deionization device of FIG. 5, according to one or more embodiments;

FIG. 7 shows a schematic of a control system, according to one or more embodiments;

FIG. 8 shows a schematic of a humidifier system incorporating a miniature capacitive deionization device according to one or more embodiments;

FIG. 9 shows a schematic of a humidifier system incorporating a miniature capacitive deionization device according to one or more embodiments;

FIG. 10 shows a schematic of a humidifier system incorporating a miniature capacitive deionization device according to one or more embodiments;

FIG. 11 shows a schematic, exploded view of a point of use humidifier device incorporating a miniature capacitive deionization device according to one or more embodiments;

FIG. 12 is a photocopy of a photograph showing a point of use humidifier device incorporating a miniature capacitive deionization device according to one or more embodiments; and

FIG. 13 shows a schematic of a gravity fed miniature capacitive deionization device, according to one or more embodiments.

### DETAILED DESCRIPTION

Capacitive deionization is known technology for at least partially removing one or more ionic species from a fluid stream. Capacitive deionization devices have been developed over the last 20 years as an alternative to more traditional deionization methods, including reverse osmosis, electrodeionization, continuous electrodeionization, ion exchange resins, lime softening, etc. Capacitive deionization can provide in certain cases the ability to remove ions with lower energy and reduced fouling compared to typical traditional deionization techniques.

Capacitive deionization works as follows. An aqueous stream containing undesirable ions is fed into a capacitive deionization device containing one or more pairs of electric double layer capacitors. A power supply is electrically coupled with opposing electrodes of the pair(s), and the capacitors are charged. A dielectric material or layer(s) is positioned in between the opposing electrodes, which hold their charge just like a standard capacitor.

When the capacitors are charged during a water treatment (cleaning) cycle of operation, the cations and anions are attracted by and move toward an electrode having an opposite charge than the ionic species (i.e. cations migrate towards the negatively charged electrode(s) and anions migrate towards the positively charged electrode(s)) and are thereby removed from water, e.g. by being adsorbed onto a capacitor electrode, which is in certain embodiments made of carbon, and/or other ion capture layer(c) in proximity to the electrode. The capacitive deionization device will eventually become saturated with ions and need to be regenerated. When this occurs, the polarity of the double layer capacitor(s) is/are reversed, and the ions are rejected from the surface of the respective electrodes or other capture layer(s) to which they are adsorbed and into a reject water stream for disposal or collection, etc.

In some embodiments a capacitive deionization device has a planar plate and frame configuration. In such a configuration, the electrodes are generally flat and stacked like plates with spacer material positional between each pair of electrodes. The flat electrode plates may have any suitable geometry—circular, square, rectangular, etc. The plates are held in place by a frame. In preferred embodiments the capacitor material forms a spiral layer or a series of separate, concentric cylindrical layers around a central axis. Such a capacitive deionization device is referred to herein as a radial capacitive deionization (RDI™) device.

A radial capacitive deionization device comprises one or more pairs of concentrically or spirally arranged opposed electrodes forming one or more capacitors, and a dielectric spacer that forms a flow path interposed between the electrodes of the capacitor pair(s). Radial capacitive deionization devices may be understood to be a form of capacitive deionization devices, albeit in certain embodiments with advantages over traditional plate and frame capacitive deionization devices. Radial deionization devices of certain embodiments may include charge barriers, such as semi-permeable membranes, that prevent discharged ions from re-adsorbing onto the opposing capacitor electrodes when the cylinder is switched to a reject cycle and the capacitors' polarities are reversed. Aspects of radial deionization units useful or adaptable for use in certain embodiments described herein are discussed in U.S. Pat. No. 9,193,612, entitled “Concentric Layer Electric Double Layer Capacitor Cylinder, System, and Method of Use,” and U.S. Pat. No. 9,633,798, entitled “Atomic Capacitor,” each of which is incorporated by reference herein in their entireties and for all purposes.

Due at least in part to the size of typical conventional radial deionization devices, applications for using the technology in portable or point of us appliances or devices have been generally unavailable or infeasible. As a solution to this and other problems, according to certain embodiments of the invention, miniature radial capacitive deionization devices are provided. These small-scale devices can be configured and constructed as described herein to be capable of effectively treating a water stream without taking up as much space as traditional devices, thereby enabling certain embodiments to be integrated within a variety of point of use water processing appliances or devices. Such devices include but are not limited to point of use and/or portable humidifiers, which are described in detail below as a preferred but merely exemplary application. Other uses for the inventive, miniaturized radial capacitive deionization devices disclosed include but are not limited to drinking water purifiers, water softeners, clothes laundering machines, dishwashers, coffee/hot beverage makers, ice makers, DI water generator for laboratories, hot water heater demineralizer, point of entry desalination for home use, etc. Accordingly, miniature radial capacitive deionization devices disclosed herein are able, in certain embodiments, to be used in applications for which capacitive deionization was previously impractical, or as alternatives for use in known applications. In preferred embodiments, the miniaturized capacitive deionization device have radial design—either comprising concentric layers or spiral layers. But, in the context of humidifier integration with a capacitive deionization device, other, non-radial designs, such a plate and frame configurations, are also contemplated and possible.

As used herein, the term miniature capacitive deionization device refers to a capacitive deionization device having an overall volume of between 50 cm³ and 2000 cm³, including its outer casing. As used herein, the term miniature radial capacitive deionization device refers to a miniature capacitive deionization device having its capacitors arranged concentrically or spirally about a central axis.

According to one or more embodiments, miniature radial capacitive deionization devices for use in treating an aqueous stream by capacitive deionization are generally described.

The miniature radial capacitive deionization device may comprise an inlet to receive an aqueous stream, and an outlet for delivering a treated aqueous stream. The device may further comprise one or more capacitors positioned within a housing and defining a flow path between and in fluid communication with the inlet and the outlet and configured to produce the treated aqueous stream. The total volume enclosed by the housing may be between 50 and 2,000 cm³, between 50 and 1,000 cm³, between 50 and 500 cm³, between 500 and 2,000 cm³, between 500 and 1,000 cm³, between 1,000 and 2,000 cm³, or any other range or value between 50 and 2,000 cm³, according to different embodiments.

Furthermore, each of the one or more capacitors may comprise the following: a first electrode; a first ion specific layer associated with the first electrode; a second electrode spaced apart from the first electrode; a second ion specific layer associated with the second electrode; and a dielectric spacer forming the flow path positioned between the first ion specific layer and the second ion specific layer and configured to receive a portion of the aqueous stream from the inlet and deliver a portion of the treated aqueous stream to the outlet.

The one or more capacitors may be arranged as a spiral or with the plurality of electrodes arranged as separate concentric cylinders.

In some embodiments, a miniature capacitive deionization device may be used in an integrated system or appliance further comprising a water processing unit fluidically coupled to the outlet to receive the treated aqueous stream. Alternatively, a water processing unit may be fluidically coupled to the inlet of a miniature capacitive deionization device to supply the aqueous stream to the device for treatment. In some embodiments, the water processing unit may form at least part of a humidifier. In some embodiments, the water processing unit and the miniature capacitive deionization device are both positioned in a common housing. These and other aspects of the disclosure are discussed in further detail below. In preferred embodiments, the miniature capacitive deionization device is a radial miniature capacitive deionization device.

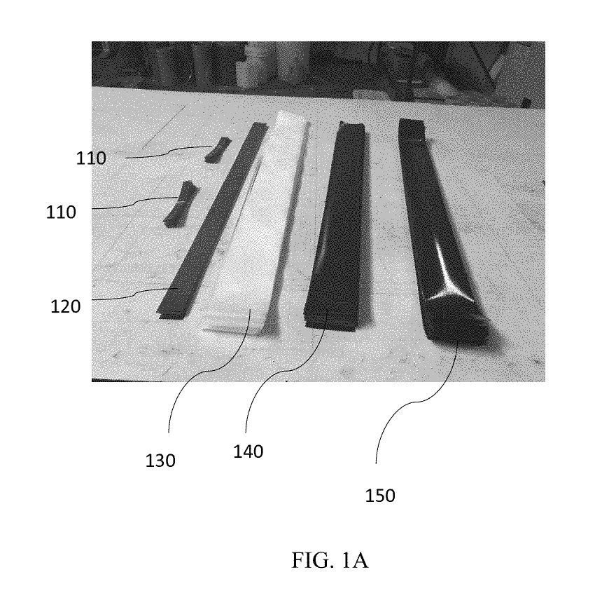

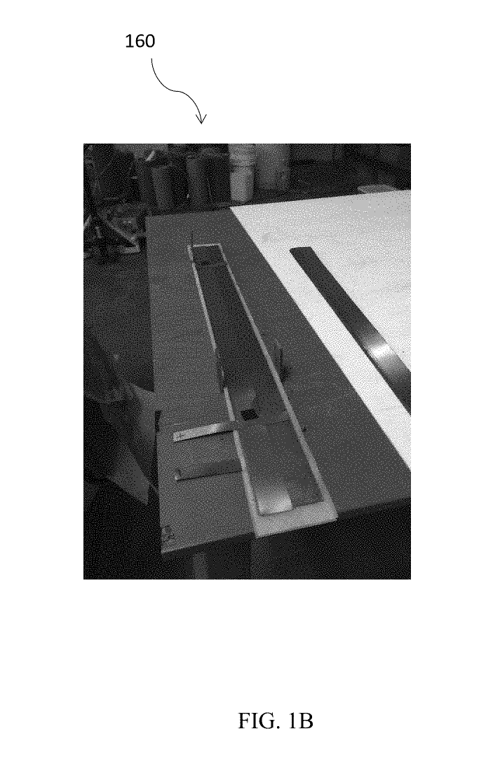

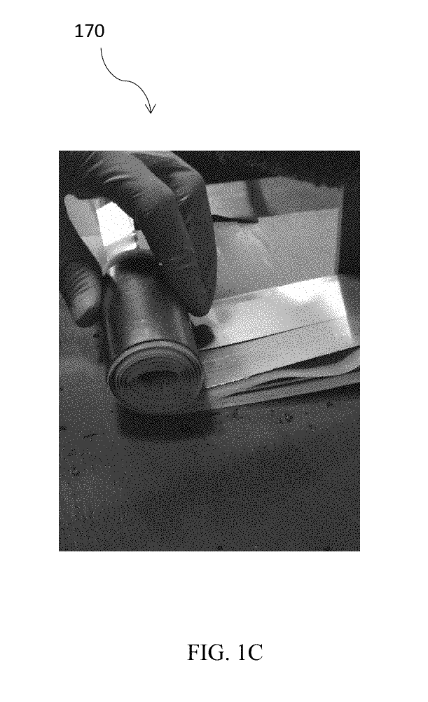

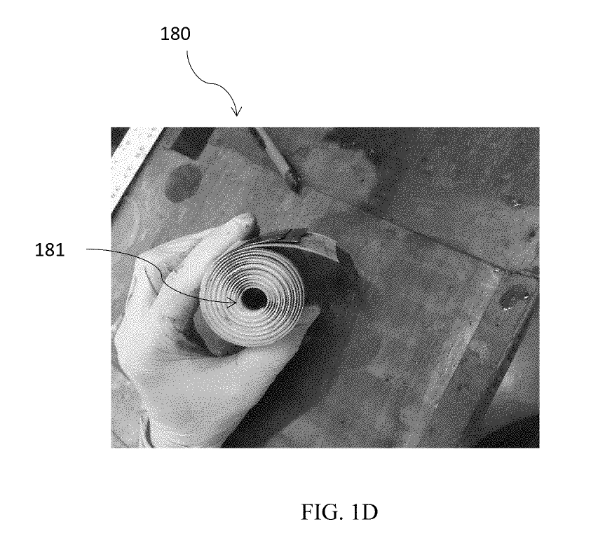

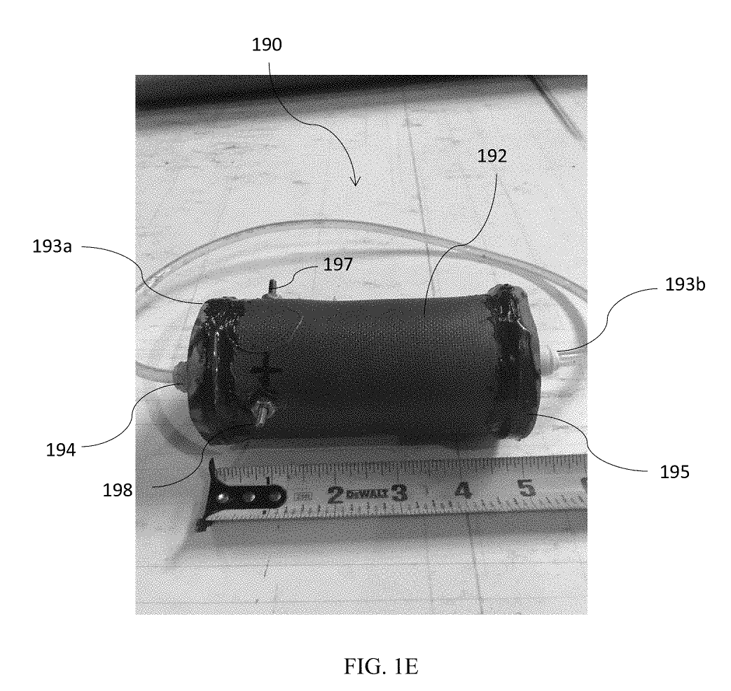

FIGS. 1A-1E illustrate an embodiment of a manufacturing process for forming a miniature spiral wound radial capacitive deionization device.

In FIG. 1A, materials for use in forming an exemplary embodiment of a spiral wound device are shown. These materials include: conductive leads 110 (e.g. formed of a conductive metal, such as titanium); current collector strips 120 (e.g. formed of a conductive metal, such as titanium); spacer material 130; combined cationic-selective membrane and electrode material 140; and combined ionic-selective membrane and electrode material 150. In an exemplary completed device, conductive leads 110 connect internal collector strips 120 to external bolts (shown in FIG. 1E). Internal current collector strips 120 serve as current collectors that run the entire length of material that is formed into the spiral, in the completed device, and reduce resistance. The spacer material 130 serves as a flow channel for water, and also functions as the dielectric of the capacitor. In some embodiments, the current collector strips 120 typically have a thickness of about 0.001 to 0.01 inches. In some embodiments, the conductive leads 110 typically have a thickness of about 0.001 to 0.01 inches. In some embodiments, the spacer material 130 may be made of many woven and nonwoven insulating materials such as hemp, nylon cloth, polypropylene, or other non-conductive materials typically has a thickness of about 0.005 to 0.020 inches.

In some embodiments the combined membrane and electrode material 140 and 150 typically has a thickness of about 0.01 to 0.02 inches, with of the combined material separately having a thickness of about 0.001 to 0.01 inches. The membrane portion typically comprises commercially available ion-selective membrane material. The membrane materially typically comprises a polymeric membrane that has been functionalized to be ion-selective. The membrane material may be similar or identical to membrane material commonly employed for electrodialysis applications. The electrode portion typically comprises carbon material, for example, carbon black, activated carbon, pseudo capacitor materials, ionic dopants, carbon nanotubes, carbon bucky-balls, etc. In some embodiments, where a combined membrane/electrode material is formed, the electrode material may be coated onto a base membrane material. Alternatively, the membrane layer and electrode layer may be provided separately. The combined electrode/membrane material may also comprise a current collector layers. According to some embodiments the combined layers are commercially available. They may be formed by coating an electrode layer onto a current conductor layer (e.g., graphoil) and allowing the coating to cure. Then coating a membrane material onto the electrode layer and allowing it to cure. Alternatively, electrode, membrane, and current conductor layers may each be provided separately.

Different layers or materials of the device may serve one or more functions. For example, any one of the layers may also be made from a material that functions as a compressive layer or spring layer, as it resists the spiral shape it has been wound into, beneficially stabilizing the devices structure. In some embodiments a current collector layer made from a conductive material that is biased toward uncoiling (e.g., titanium) also serves as a spring layer.

Each of the components of FIG. 1A prior to assembly may have a width of about one to ten inches, the approximate equivalent of the height from end to end of the resulting miniature spiral wound capacitive deionization device, minus about an inch of space at each end of the resulting device. The materials may have a sufficient length in the direction in which they will be wound of to result in a final diameter of the device of about one to three inches. For example the materials shown in FIG. 1A have a length of about 30 inches. When the device is electrically coupled for operating in a purification mode, the combined cationic-selective membrane and electrode material 140 is negatively charged and adsorbs positively charged (cationic) ionic species from the flow stream to produce a treated stream. When operating in a reject mode, the polarity is reversed and the combined cationic-selective membrane and electrode material 140 is positively charged, repulsing the previously adsorbed cationic species through the cationic-selective membrane material and into a brine reject stream. The combined anionic-selective and electrode material 150 operates similarly, with the charges reversed, to remove anionic material from a treated stream and return those anions to a brine reject stream. The capacitor material 140 and 150 may also comprise a coating (e.g., a graphite coating) to function as current collector.

In FIG. 1B, the materials described in FIG. 1A are shown mid-manufacturing process arranged in the layers that will be spirally wound. The arrangement for the stacked layer 160 in the embodiment shown is, from bottom-up, as follows: combined cationic-selective membrane and electrode material 140; spacer material 130; combined ionic-selective membrane and electrode material 150; titanium strip 120; titanium lead 110 (together functioning, in this case, as the anode of the resulting capacitor device); combined ionic-selective membrane and electrode material 150; spacer material 130; combined cationic-selective membrane and electrode material 140; titanium strip 120; and titanium lead 110 (together functioning, in this case, as the cathode of the resulting capacitor device).

Continuing with the manufacturing process, FIG. 1C shows layer 160 as formed into a partially wound spiral 170, with the material arranged in the layers described with regard to FIG. 1B, while FIG. 1D shows the completed spiral wound stack 180.

FIG. 1E shows the spiral wound stack 180 as assembled into a completed miniature spiral wound capacitive deionization device 190. In the final device 190, the spiral wound stack 180 is encased in a housing 192. In this embodiment, the housing 192 is formed by wrapping a fiberglass material around the spiral wound stack 180 and affixing ends 193a and 193b to formed a water-tight outer containment. External bolts 197 and 198 connect to internal titanium leads 110. Inlet 194 is connectable to a source that delivers water into the device, and outlet 195 delivers treated or brine water (depending on the mode of operation) from the device 190, during operation.

In the embodiment shown in FIGS. 1A-1E, to save space and provide a compact design, there is no inner support tube around which the layers are spirally wrapped, as is more conventional for larger scale devices. It was found that, according to some embodiments eliminating an inner support tube could further facilitate a reduction in the size of the final device. Furthermore, it was found in some embodiments that eliminating an inner support tube could improve performance by reducing or eliminating certain issues related with compression and cracking of material when attempting to produce a miniature spirally wound capacitive deionization device.

Without being confined to a particular theory, it is believed that use of a wound titanium (or similar spring or spring-like material biased to resist coiling) layer 120 creates spring-loaded tension on the spiral roll, imparting a beneficial compression on the stack resulting by the titanium coil attempting to unwind. In this manner, the wound titanium layer (or similarly resilient material, e.g. spring steel or the like) functions in a manner similar to a mainspring in a watch or clock mechanism proving an outwardly bias force in its effort to unwind. This imparted compression can stabilize the layers of the device against the outer casing. Use of a metal such as titanium or stainless steel may allow the spring layer to also function as a current collector layer. The combined spring and current collector layer (e.g., titanium layer) preferable runs the a substantial portion of or essentially the entire length of the material coiled to make the radial stack prior to coiling/roll-up.

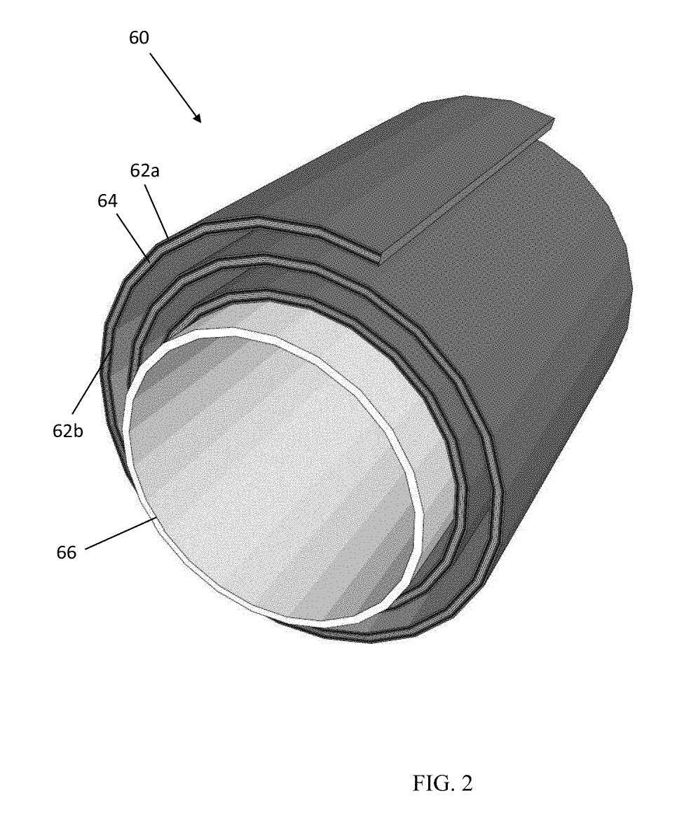

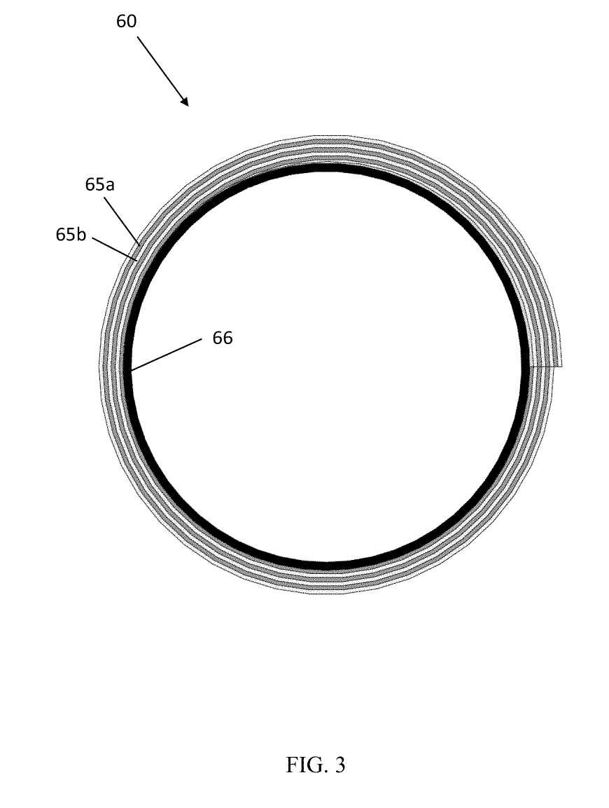

FIG. 2 shows an alternative spiral wound device 60 in which a group of pre-arranged layers of material comprising combined capacitor and ion-selective membrane material 62a and 62b and a spacer region for fluid flow 64 are wrapped around a core 66. This group is organized such that the surfaces that come in contact with each other are the same polarity. In this embodiment, two sets of electrodes 62a and 62b are pre-arranged and then wrapped around a core support tube 66. When the desired surface area of active materials are installed, the wrap is terminated and an outer casing may be installed, as described above. For the sake of clarity, FIG. 2 does not show all components of the final radial capacitive deionization device and shows the material partially unwrapped in a looser form to lake the layers more visible than would be the case in the final configuration. FIG. 3 shows the completed spiral layers in cross-section. The cylinder 60 of FIG. 3 shows a single spiraled capacitor pair formed of two electrods 65a and 65b wrapped around the core support tube 60. Each of the wound capacitors 65a and 65b comprises a spacer region therebetween with ionic-selective membrane material on either side of the electrodes.

As a further alternative in either of the above configurations (FIGS. 1A-1E of FIGS. 2-3), a centrally disposed spring (not shown) surrounded by the one or more capacitors, may be positioned within the central axial space 181 of the embodiment if FIG. 1A-1E (see FIG. 1D) or positioned around or replacing central tube 66 of the FIG. 2-3 embodiment. The centrally disposed spring is may conveniently be coiled, like the mainspring of a watch, and may provide a biasing force to compress the capacitors against an outer casing. In the embodiment of FIG. 1A-E, the centrally disposed spring may be used instead of or as a supplement to the biased coiled layer 120 described previously. The centrally deposed spring may be made of any material capable of providing an outwardly biased force when wound, such as titanium or spring steel. Plastics and other metals are also possible.

As an alternative to a spiral wound configuration, the miniature radial capacitive deionization device may comprise separate, cylindrical capacitors arranged in a concentric layer pattern. Such a device may be referred to as a miniature concentric layer radial capacitive deionization device. Concentric layer radial capacitive deionization devices reduced in size can also advantageously be used in applications where a smaller device is advantageous or required.

Miniature concentric layer radial capacitive deionization devices in certain embodiments are capable of comparable, substantially similar or essentially equal deionization performance (in terms of the fraction of ions initially present that are removed) as conventional, larger size devices but at a fraction of the size.

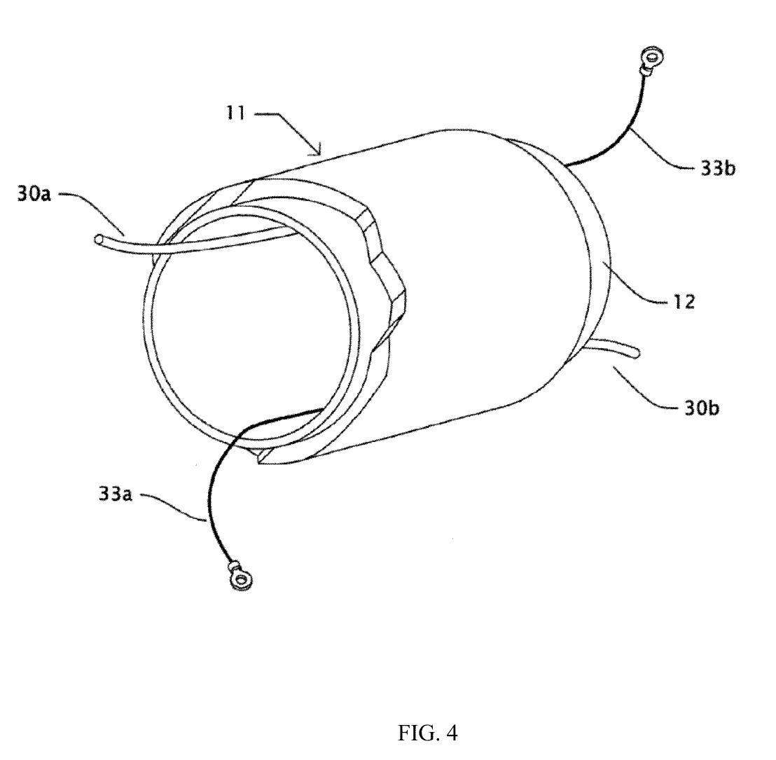

FIGS. 4-6 provide further description of embodiments of exemplary concentric layer radial capacitive deionization devices useful for practicing certain disclosed embodiments.

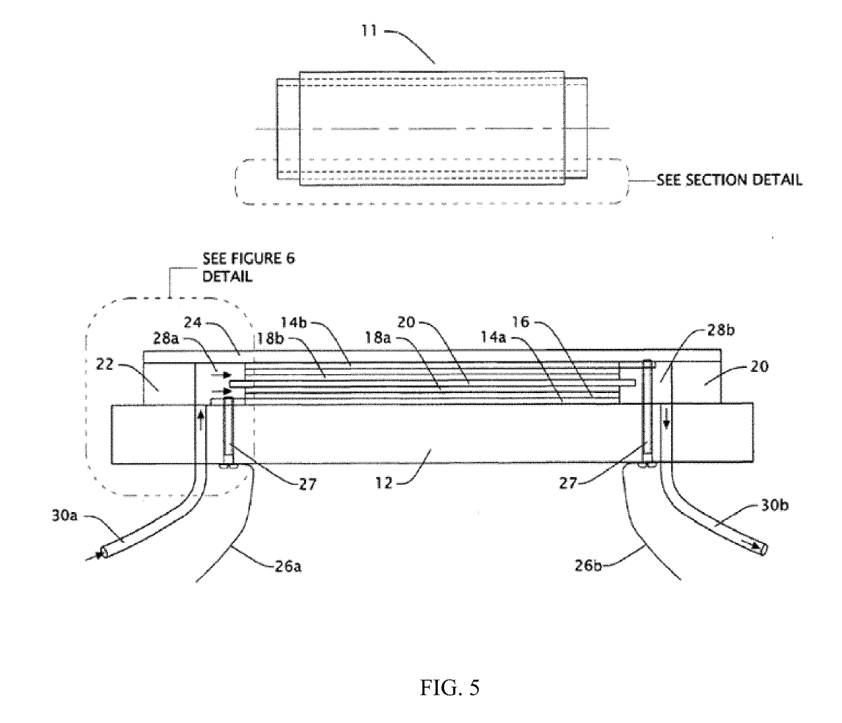

Turning to the embodiment shown in FIGS. 4-6, a concentric layer capacitor cylinder 11, comprises two or more tubular electrodes 16 forming concentric capacitor layer(s) (FIG. 5). The separate, cylindrical electrodes 16 are inserted inside of one another forming concentric, cylindrical capacitors. One pair of electrodes forms each cylindrical electric double layer capacitor.

In the design shown in FIG. 5, an inner most capacitor electrode 16 is wrapped around a current collector 14a, which could be a graphite rod, a hollow metallic tube or a non-metallic hollow tube 12 with a metallic coating, sleeve, or thin current collector 14a. Around this inner capacitor electrode 16 could be an ionic membrane 18a or an ionic coating integrated onto a surface of capacitor electrode 16. Next, a dielectric spacer, insulator, or spacer 20 would surround a capacitor electrode 16 or membrane 18 which would allow for a liquid layer to flow through the capacitor layers of cylinder 11. Around this layer would be another ion selective membrane 18b, another capacitor electrode 16, and then another current collector 14b.

Around a perimeter of each end of hollow support tube 12 is an optional o-ring 22 to seal ends of cylinder 11. A sealing layer 24 wraps around cylinder 11, extending out to o-rings 22 which will completely seal cylinder 11 and provide means to compress layers within cylinder 11 securely against inner support tube 12.

Process liquid connections 30a and 30b to cylinder 11 mount on the inside of inner support tube 12 and allow for liquid access to inlet 28a and outlet chambers 28b. Electrical connections 26a and 26b to cylinder 11 are also made through inner surface of inner mounting tube 12.

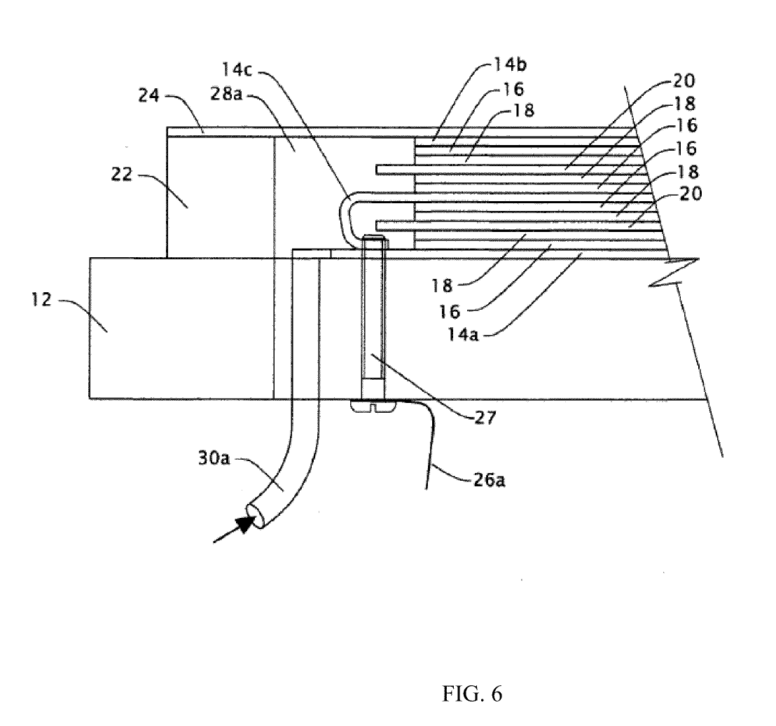

FIG. 6 shows a detail view of a concentric layer capacitor cylinder with a plurality of electrodes visible. The structure of the cylinder is the same as illustrated in FIG. 5 except that an internal current collector 14c is placed onto second capacitor electrode 16. On top of current collector 14c is placed another capacitor electrode 16, another membrane 18, another dielectric spacer 20, another membrane 18, and then another capacitor electrode 16. This sequence can be repeated until the desired number of pairs of electrodes forming capacitors is installed onto inner mounting tube 12.

When cylinder 11 is operating as capacitive deionization device, liquid to be processed such as water enters cylinder 11 through inlet tube 30a into inlet chamber 28a. The liquid passes axially through spacer(s) 20, into outlet chamber 28b and then out of cylinder 11 through tube 30b. The size of chambers 28a and b can be further reduced by filling with a space filling material such as foam.

In this or the spiral configurations described previously, operation can proceed as follows. Electrical leads, such as leads 26a and 26b as illustrated in FIG. 5, are connected to a direct current power supply (DC). The simplest cylinder design has one capacitor electrode 16 connected to one leg of a power supply and another capacitor electrode 16 connected to another leg. The power supply is turned on and each capacitor is charged to the voltage set on the power supply. In some embodiments, the power supply would be set to 2.2 volts when processing aqueous liquids.

If capacitor electrode 16 nearest inner support tube 12 is charged positive it will attract negatively charged ions (anions). If membrane 18a proximal to this capacitor electrode 16 is anionic, it will allow anions from the liquid in spacer 20 to pass through and adsorb onto capacitor electrode 16. This adsorption will continue until the amount of ionic charge adsorbed onto capacitor electrode 16 equals the charge capacity of capacitor electrode 16. Conversely, capacitor electrode 16 nearest outer casing 24 will be charged negative and attract positively charged ions (cations). If membrane 18b proximal to this capacitor electrode 16 is cationic, it will allow cations to pass through until capacitor electrode 16 is full.

Once capacitors electrodes have adsorbed the prescribed amount of ions (partial or full adsorption), the polarity of the power supply is switched. Capacitor electrodes that were charged positive are now switched to negative and other capacitor electrodes that were charged negative are now switched to positive. The ions that were adsorbed onto the surface are now repelled towards oppositely charged capacitor electrodes. Since opposite ion specific membranes 18 are placed in front of each capacitor electrode, the repelled ions cannot pass through the membrane and are prevented from adsorbing onto oppositely charges capacitor electrode. These rejected ions are held within spacer 20 and can be expelled from cylinder 11.

After all the ions have been dislodged from the capacitor electrodes 16 and cylinder 11, the adsorption and rejection process can be repeated. If a 3 way valve (or multiple 2 way valves) is placed on outlet tube 30b, the deionized liquid can be diverted away from the liquid containing the rejected ions. Cylinder 11 power supply will switch the polarity back and forth, removing ions from solution and depositing the ions back into solution, creating a deionized portion and a portion containing the removed ions.

For both radial and concentric cylinder configuration embodiments, typical component sizes and materials of construction according to certain embodiments may be as follows. The inner support tube 12, having an internal diameter of 0.5 to 4 inches in some embodiments, can be made of fiber reinforced epoxy resin, fiber reinforced polyester resin, schedule 40 or 80 ABS pipe, PVC, PPE, PP, or the polymers with semi-rigid structure. The current collector 14a, 14b, or 14c is typically made of less than 0.010″ commercial grade titanium. The carbon capacitor electrodes 16 are typically made of activated carbon, >0.005″ thick, with surface area greater than 1,000 m³/gm. The spacer 20 can be made of many woven and nonwoven insulating materials such as hemp, nylon cloth, polypropylene, or other non-conductive materials that wet-out in water with open volume less than 75% and thickness greater than 0.005″. Optional o-rings 22 sealing each end can be made from rubber, silicone, PTFE, or other flexible sealing materials.

In miniature radial capacitive deionization devices, which may be from 1 to 3 inches in diameter and 3 to 12 inches in length, or 2.5 to 6 inches in some embodiments, inlet (e.g. 28a) and outlet (e.g. 28b) chambers may about 20 to 100 ml, according to some embodiments. A radial capacitive deionization device of this configuration may allow for flow of approximately 100 to 2,500 ml/min. This translates into a residence time or dead volume of less than 1 second. As additional electrode pairs for concentric or windings for radial configurations are added to cylinder 11 the dead volume will rise less than proportional, further reducing the residence time in chambers 28a and 28b. By reducing the residence time in outlet chamber 28a to less than 1 second, there is a clear delineation between cleaned and purged liquid streams when the polarity is switched. Using the same diameter cylinder mentioned above, the residence time of the open space contained in spacer 20 is in some embodiments from about 0.1 to about 5 seconds, according to certain embodiments. In some embodiments, the velocity of the liquid within spacer 20 is sufficient to create turbulence which will facilitate the removal of ions after being ejected from capacitor electrodes 16 during the discharge cycle, according to certain embodiments.

The combination of these two features may significantly reduce the effect of the problem of the clean stream being mixed with stream containing the rejected ions.

Current collectors 14a and 14b, or integrated capacitor electrodes 16/current collectors 14, are very close to inside and outside of the cylinder 11. This allows for simple and effective electrical connection to outside power source. A non-porous current collector may be employed, thereby reducing the electrical resistance such as described above. When employing multiple concentric electrode pairs of layers of winding of a spirally wound electrode pair(s) within cylinder 11, non-porous collectors 14c (e.g. titanium collectors 120 described previously) may be used to facilitate assembly and reduce electrical resistance. The same materials discussed in regards to the concentric layer embodiments may also be incorporated for the corresponding components in the spiral wound miniature capacitive deionization devices.

Higher flow rate of the device (ml/min per m² of active material) across active material increases the removal rate of salt (gms/min per m²), thereby requiring less capacitor/membrane material and hence lower system cost. In some embodiments, the miniature device operates as a constant voltage system, thereby delivering higher average current density to the capacitors. Higher current density equates to a higher removal rate of salt, thereby further reducing the size and cost of system. As system size is reduced, so is maintenance cost per unit of water produced. The capacitor design allows for a shorter path for the water to travel, improving the clean water recovery.

Miniature radial capacitive deionization devices as disclosed herein may be operated as part of a process associated with a water processing unit. In some embodiments, methods of treating an aqueous stream are generally described. The method may comprise feeding water from a source of the water to a miniature radial capacitive deionization device enclosed within a housing having a volume between 50 and 2000 cm³. The water may be treated within the miniature radial capacitive deionization device to produce a treated water. The treated water may then be delivered to a reservoir or water processing unit.

Treatment of water within the miniature radial capacitive deionization device may comprise feeding the water into the miniature radial capacitive deionization device and at least partially removing at least one ionic species from the water to produce the treated water. In some embodiments, the water processing unit may be a humidifier unit, such as a point of use humidifier, as discussed in greater detail below.

In some embodiments, the water processing unit may be an office water dispenser. The water processing unit may be a laboratory water dispenser. In some embodiments, the water processing unit may be a hot water heater demineralizer. In some embodiments, the water processing unit may be a home water dispenser. In some embodiments, the water processing unit and the miniature radial capacitive deionization are both positioned in a common housing.

The at least one ionic species at least partially removed may comprise one or more of Li, Na, Ca, Mg, K, U, Hg, Se, Ba, Sr, Fe, Mn, Cr, Ni, Cu, Zn, Sn, Sb, Pb, chlorides, sulfates, sulfides, sulfites, nitrates, phosphates, carbonates, borates, silica, selenates, selanites, bromides, iodides, and alkalines. At least one ionic species at least partially removed may comprise at least one hardness ion. At least one ionic species at least partially removed may comprise sodium and chlorine. The water from the source of water may be at least partially desalinated by the miniature radial capacitive deionization device.

According to one or more embodiments, miniature radial capacitive deionization devices as discussed above may operate at relative low wattages. In some embodiments the devices operate at between 1 W and 10 W, or between 4 W and 6 W on average.

Some embodiments of the described systems and methods provide advantages regarding flow rate optimization. In some embodiments, miniature capacitive deionization devices have the ability to desalinate water at comparatively high flowrates. The higher flow rates can increase the flux rate of the system, thereby allowing for smaller systems to be utilized. According to one or more embodiments the miniature radial deionization devices may be operated at flow rates between 10-800 mL/min or 50-4000 ml/min per m² of active material. In some embodiments, the device may be operated at a flow rate of 400 to 600 ml/min, or 2000 to 3000 ml/min per m² of active material (combinations of these values, as well as other values, are also possible). Active material as used herein refers to capacitor material capable of adsorbing ionic species and is measured as bulk area of the material.

The feed water introduced into the miniature radial capacitive deionization device may have a conductivity of between about 100-2,500 μS/cm. The treated water produced by the device may have a conductivity of between 1 μS/cm and 100, 200, or 300 μS/cm.

In some embodiments, the miniature radial capacitive deionization device may be operated to selectively allow at least one ionic species to pass through without substantial removal from the water to produce the treated water.

Humidifiers are devices designed to introduce water vapor or water mist into a local atmosphere, generally in an enclosed space, to increase its humidity. Humidifiers are available in different sizes. In the home, point-of-use humidifiers are commonly used to humidify a single room or adjacent rooms, while whole-house or furnace humidifiers, which connect to a home's HVAC system, provide humidity to the entire house. Medical ventilators often include humidifiers for increased patient comfort. Large humidifiers are used in commercial, institutional, or industrial contexts, often as part of a larger HVAC system.

Addressing the above-described challenges with regard to contaminants in the feed water is particularly challenging for humidifiers generally, and especially for point-of-use humidifiers because space and energy considerations limit the options for incorporating water treatment. Point-of-use humidifiers may be characterized by the following: portability (relative to whole-house humidifiers and industrial humidifiers, which are typically immobilized in place); a smaller overall size; use of a water reservoir (generally filled by a user, manually); operation on a standard home electrical supply (e.g., 110 V/240 V, 60 Hz in the U.S.); rate of water it cycles through (generally between 0.1 and 2 liters/hr); and general design to humidify a single room or adjacent rooms.

According to one or more embodiments, humidifier systems comprising a humidifier unit and a capacitive deionization device, for example a miniature radial capacitive deionization device described herein, are disclosed. In some embodiments, a miniature capacitive deionization device may be enclosed within a first housing having a volume of between 50 and 2000 cm³. The capacitive deionization device may be fluidically coupled with the humidifier unit. The capacitive deionization device may be positioned within a second, common housing with the humidifier unit. The humidifier system may be a point-of-use humidifier system.

The humidifier may further comprise a reservoir for holding water to be humidified. The reservoir may be fluidically coupled with an inlet of a humidifying mechanism (i.e., a mechanism for introducing water vapor to the surrounding atmosphere). The humidifier unit may incorporate any suitable humidifying mechanism for introducing the water vapor into the surrounding atmosphere, known to a person of ordinary skill in the art now or in the future. In some embodiments the humidifying mechanism is a water vaporizer or a water mister. In such embodiments, the reservoir may be fluidically coupled to an inlet of the water vaporizer or water mister.

In embodiments incorporating a water vaporizer, the water vaporizer may comprise a heating element configured to heat the water to form a water vapor. In some embodiments, the water vaporizer may comprise a water absorptive matrix and a fan positioned to circulate air through the water absorptive matrix to form a water vapor. In embodiments incorporating a water mister, the water mister may be an ultrasonic mister that forms a water mist. Other water vaporizers and water misters are also considered within the scope of the disclosure.

According to one or more embodiments, methods and systems described herein a miniature capacitive deionization device forming part of a humidifier system and coupled with a humidifier unit is able to remove monovalent and multivalent (e.g., divalent) ions from the water, and thereby reduce its salinity, or other ionic parameter. The treated water may then be delivered to a humidifying mechanism. This may be done by forming a humidifier system pairing a humidifier with a miniature capacitive deionization device. In some embodiments, the miniature capacitive deionization device that is paired with the humidifier may have a plate and frame design. In preferred embodiments, it may have a radial design—either comprising concentric layers or spiral layers, as disclosed previously, i.e. having its capacitor electrodes arranged concentrically or spirally about a central axis.

According to one or more embodiments, the humidifier unit and the miniature capacitive deionization device are contained within a common housing. As understood herein a common housing also includes embodiments having a removable water reservoir.

Use of a miniaturized capacitive deionization device may lead to a variety of configurations and processes that can substantially reduce the amount of mineral buildup in a humidifier, leading to decreased costs and maintenance times and a more positive user experience.

Incorporation of a miniature capacitive deionization device into a humidifier system provides an improved means for reducing total dissolved solids (TDS) from the water inside humidifiers. Ion exchange cartridges are used in some instances but are not economical. Meanwhile, other desalination technologies are often unsuitable for this application due to the small footprint and low energy consumption of a point-of-use humidifying device. Capacitive deionization is uniquely suited for point of use humidifier applications, because, unlike Reverse Osmosis or other typical desalination technologies, it can be sufficiently miniaturized as disclosed herein, can operate at low feed pressures, produces a low relative (to treated water volume) reject brine volume, and has low energy usage. Capacitive deionization devices disclosed herein can be miniaturized to at or below a volume of, for example, of 2000 cm³, 1500 cm³, 1000 cm³, 500 cm³, or as low as 50 cm³.

For a humidifier system incorporating a miniature capacitive deionization device, the components may be arranged in a variety of manners.

In some embodiments, the miniature capacitive deionization device is fluidically positioned upstream of the reservoir and configured to deliver a treated water stream to the reservoir. In this process, water, commonly tap water, is fed into the deionization device. The device uses a low DC voltage to remove at least a portion of at least one ionic species from the flowing water, which exits an outlet of the device as a treated water. This treated or clean water is then delivered to the humidifier reservoir, which can then be utilized by the humidifier device at a later time. In this process, the capacitive deionization device spends a portion of time deionizing the water and producing a clean stream of water and it spends a portion of time regenerating the device and forcing the accumulated salt into a secondary brine stream. This reject brine is not sent to the reservoir, and it is accordingly collected and/or discarded.

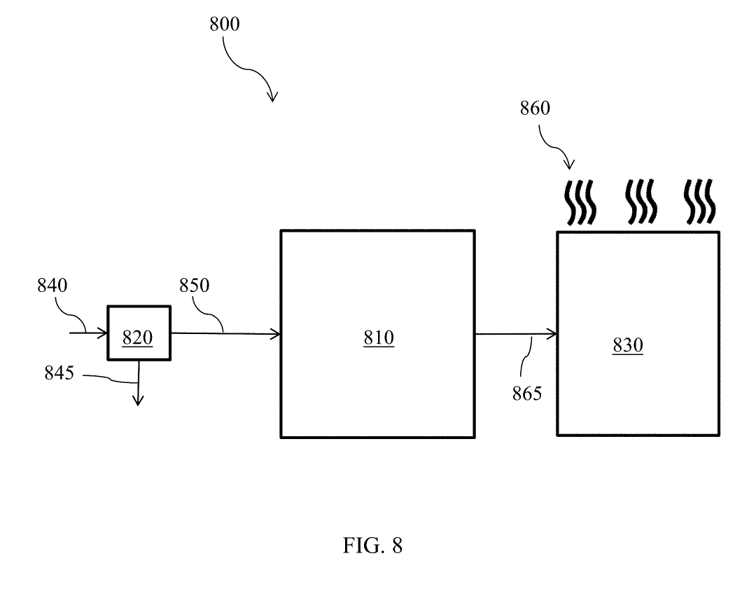

FIG. 8 shows a schematic of a humidifier system 800, which serves as an example of such a configuration. The system 800 comprises a miniature radial capacitive deionization device 820 positioned upstream of a reservoir 810. A humidifying mechanism 830 is positioned downstream of the reservoir. In operation, a water stream (e.g., tap water) is introduced to the miniature radial deionization device 820 via flow path 840.

When operating in a treatment mode (or equivalently using alternative language—a purification mode/cycle or cleaning mode/cycle), the miniature radial capacitive deionization device 820 removes a portion of the dissolved solids (ionic species) from the water to produce a treated water having a reduced dissolved solids content. This treated water is then delivered to the reservoir 810 via flow path 850. Because the treated make-up water has a reduced solids content, the accumulation of dissolved solids in the system 800 can be reduced, resulting in improved performance and increased system lifetime. The ions collected by the miniature radial capacitive deionization device 820 during purification mode are eventually rejected during a desorption mode (or equivalently using alternative language—a discharge mode/cycle, reject mode/cycle or purge mode/cycle) and released to drain or for collection/further processing via purge line 845.

The treated water in the reservoir 810 may then be introduced to the humidifying mechanism 830 via flow path 165. The humidifying mechanism 830 then introduces water to the surrounding local atmosphere as vapor or mist 860. Without the presence of a water purification device such as device 820, this process would increase the concentration of any dissolved solids in the system increasing fouling.

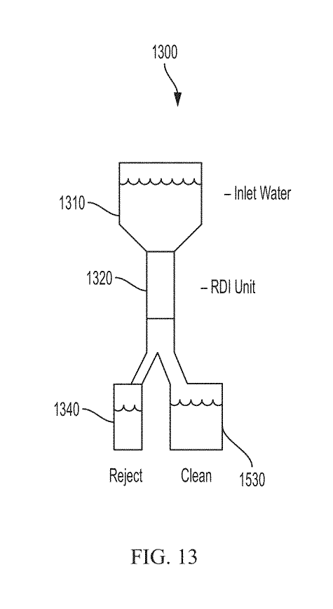

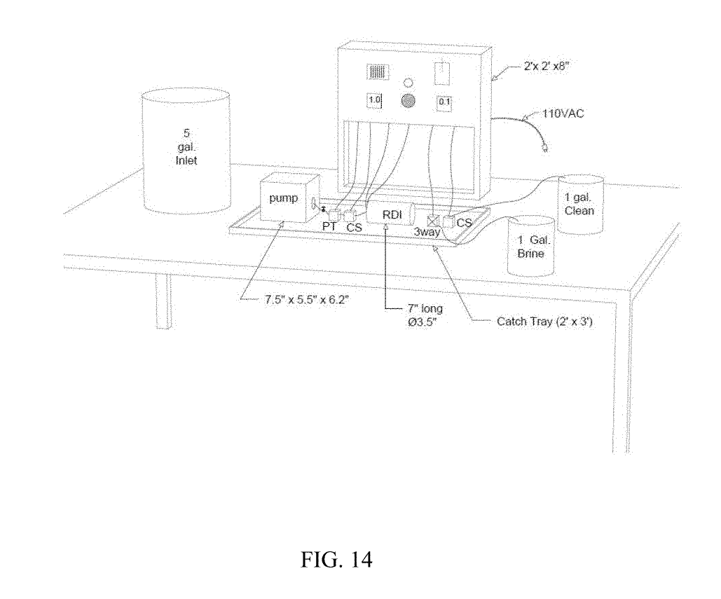

Within this basic schematic, particular system details may vary. For example, FIG. 13 shows an example flow path from a deionization device to a reservoir, that is in conformity with the schematic of FIG. 8, and operates as a gravity-fed device. In the embodiment shown in FIG. 13, showing a portion of a system, or subsystem 1300, water is introduced through a funnel 1310 that feeds the water through the deionization device 1320 by gravity. Valving at the outlet of the device may direct the water to either to a reservoir 1330 containing treated water or a brine tank 1340 depending on the mode of operation of the device. In other embodiments, the water may be fed to and through the deionization device through use of an electrically or manually operated pump.

The water fed to the capacitive deionization device 820 may vary over a large range, such as from 5 □ to 60 □, and often will have a conductivity between 300-2,000 μS/cm, although certain embodiments of the miniature radial capacitive deionization devices described herein may be capable of treating feeds having a much higher conductivity, for example up to 200,000 μS/cm. The capacitive deionization device in certain embodiments may be controlled to selectively reduce conductivity over a full range of 0% to 99% as determined by the needs of the application, but will in some embodiments be operated to reduce the conductivity of the water, by at least 25%, and in certain cases between 25% to 90%. In some embodiments the treated water has a conductivity of at least 10 μS/cm, 30 μS/cm, 100 μS/cm, or 300 μS/cm or within a range of any of these values. The conductivity of the treated can be controlled depending on the needs of the system In certain embodiments, 90% or more of the total water fed to the deionization device may be treated and pass onto the next stage as cleaned water, with as little as 10% or less of the water initially fed to the device being retained to be used during a reject cycle to produce a brine, which may be sent to the drain during a reject/regeneration cycle of operation of the device. The flow rate during the water treatment step depends on a number of conditions particular to a specific application, including, but not limited to, the size and water demands of the system, the ambient temperature, and the conductivity of the inlet water, etc. While typically not critical, the water pressure through the miniature capacitive deionization device may for certain typical applications be maintained at about less than 1 to 50 psi or more.

According to some embodiments, the miniature capacitive deionization device is fluidically positioned to receive a water stream from the reservoir and return a treated water stream to the reservoir. In such embodiments, water, commonly tap water, may be fed directly into the reservoir. The water is then recirculated through the capacitive deionization device, instead of, or in addition to, desalinating the make-up water before it reaches the reservoir. Treated water is returned to the reservoir, and brine is removed from the system to be discarded accordingly. This mode of operation may be referred to as side streaming or “feed and bleed.” This configuration may effectively deionize water within a humidifier system, and it can function well for a variety of sizes of humidifier systems.

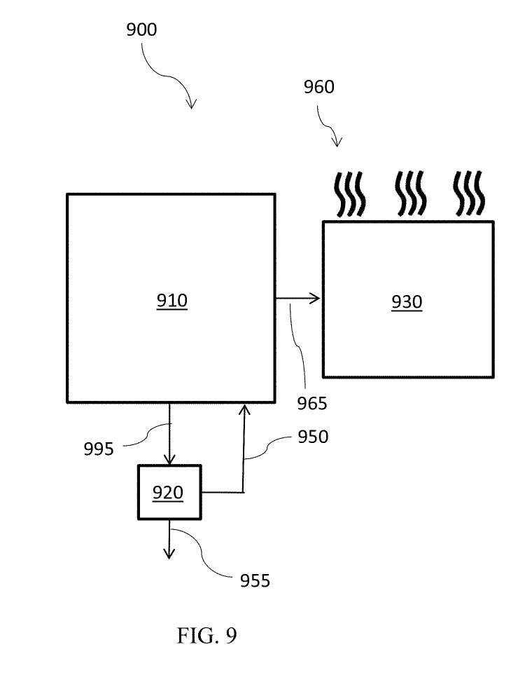

For example, FIG. 9 shows a humidifier system 900, incorporating a side-streaming deionization configuration. Water is delivered from a reservoir 910 to a humidifying mechanism 930 via flow path 965, which introduces the water 960 into the local atmosphere as vapor or mist. A miniature capacitive deionization device 920 is incorporated into the system 900 to reduce the dissolved solid content of the water in the reservoir 910. During operation, the miniature capacitive deionization device 920 receives water from the reservoir 910 via flow path 945. Treated water is then returned to the reservoir 910 via flow path 950. The accumulated ions in the miniature capacitive deionization device 920 are occasionally disposed of via purge line 955 during operation during a discharge mode.

According to some embodiments, the miniature capacitive deionization device is fluidically positioned between the reservoir and inlet of the humidifying mechanism (e.g., water vaporizer or water mister) and is configured to receive a source of water from the reservoir and deliver a treated water stream to the humidifying mechanism (e.g., water vaporizer or water mister).

In such embodiments, water, commonly tap water, is fed directly into the reservoir. The water is then delivered to a miniature capacitive deionization device. The device undergoes the same fundamental operation as discussed throughout this disclosure, and creates a deionized stream of water delivered directly to the humidifying mechanism, and produces during a purge cycle a brine stream to be discarded. The advantages of such a configuration is that it can deionizes the water on an as-needed basis. The flow rates could potentially be very low (e.g., 25 ml/min or less), and thus the size of the deionization device, and the overall system, could be further reduced.

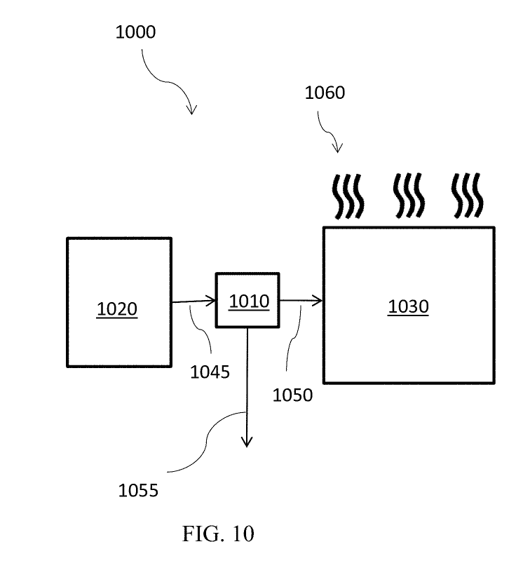

For example, referring to FIG. 10, humidifier system 1000 comprising a miniature capacitive deionization device 1010 positioned between a reservoir 1020 and a humidifying mechanism 1030. In operation, water (e.g., tap water) is introduced to a reservoir 1020. It is then delivered to a miniature capacitive deionization unit 1010 via flow path 1045. During operation in a treatment mode, a treated water is delivered from the device 1010 to a humidifying mechanism 1030 via flow path 1050, which introduces the water 1060 into the local atmosphere as vapor or mist. The accumulated ions in the miniature capacitive deionization device 1020 are occasionally disposed of via purge line 1055 during operation during a discharge mode. The same temperature and conductivity values described with regard to FIG. 8, also generally apply to the systems described in FIGS. 9 and 10.

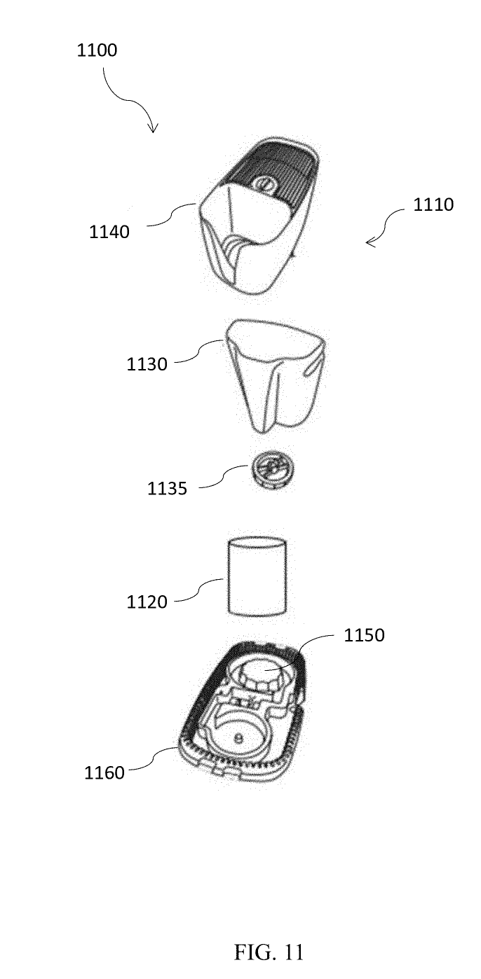

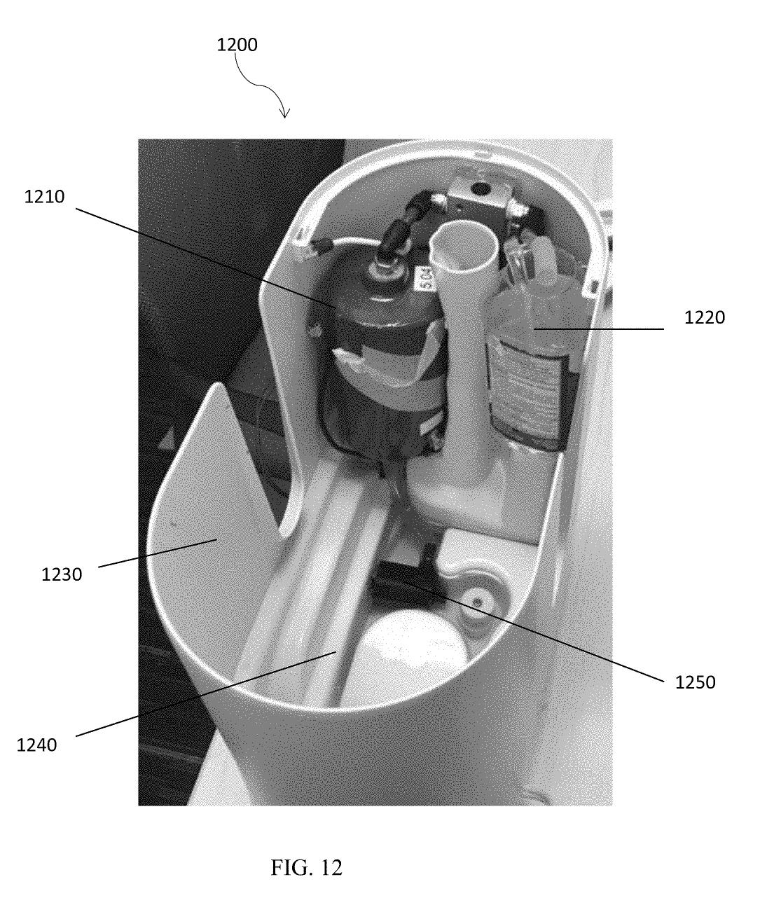

FIGS. 11 and 12 show non-limiting examples of point of use humidifier systems incorporating a miniature capacitive deionization device. FIG. 11 provides an exploded view of a point of use humidifier system 1100. The system comprises a miniature capacitive deionization device 1120 coupled to a humidifier unit 1110. The humidifier unit 1120 comprises a pump motor (alternative embodiments, may be gravity fed) contained within upper enclosure 1140 and a reservoir 1130 with a fill cap 1135. The unit 1110 further comprises a heating element 1150 in the system's base 1160. A housing formed by upper enclosure 1140 and base 1160 encloses both the heating element 1150 and the miniature capacitive deionization unit 1120. In this example, the miniature capacitive deionization device 1120 is fluidically positioned between the reservoir 1130 and the heating element 1150, in a configuration similar to the schematic shown in FIG. 10.

FIG. 12 shows another example of a point of use humidifier system 1200. The system 1200 operates in a side stream configuration like that discussed above with regard to FIG. 9. Water in a reservoir 1240 contained by a housing 1230 is delivered via pump 1250 to a miniature capacitive deionization device 1210. When operating in a treatment mode, the output from the device 1210 is recirculated to the reservoir 1240. When operating in a reject mode, the output from the device 1210 is delivered to a brine tank. 1220.

In this example the device 1210 is powered by a circuit board power supply, which switches polarity to the capacitor electrodes back and forth for treatment and purge cycles per preset timers. A typical clean flow rate in this example is approximately 425 ml/min, with a brine flow rate of approximately 50 ml/min, during clean and purge cycles, respectively, although these values are exemplary and should not be considered limiting.

In operation, miniature capacitive deionization devices described herein may be incorporated into methods for treating a water associated with a point of use humidifier system. A water stream may be introduced to a miniature capacitive deionization device. The miniature device may be enclosed within a first housing having a volume between 50 and 2000 cm³. In some embodiments the housing may be between 50 and 500, 1000, or 1500 cm³. The miniature capacitive deionization devices are preferably but not required to be miniature radial capacitive deionization devices. The water may be treated within the miniature capacitive deionization device to produce a treated water. The treated water may then be introduced to a humidifying unit contained within a second, common housing together with the miniature capacitive deionization device. The humidifying unit may be operated to humidify a local atmosphere (e.g., the room within which it is located) with the treated water by generating a water vapor or water mist with the humidifying unit. In some embodiments the device may treat water at a rate of between 300 and 800 ml/min.

According to certain embodiments, a control system may be incorporated into the system to improve the operation of the miniature capacitive deionization device and other system components. The control system may comprise a controller, at least one input device (e.g., a sensor), and at least one output device (e.g., a pump and/or valve(s)). The controller may be configured to receive an input signal from the input device and to deliver an output signal, in response to the input signal, to the output device. For example, in certain embodiments, the miniature capacitive deionization device may be coupled to a controller configured to receive an input signal from a sensor monitoring a salinity in the reservoir or feed stream, and to deliver an output signal, in response to the input signal, to a pump and/or valve.

Unlike reverse osmosis which can only be fed by its own high pressure pump and produce a single output salinity, in some embodiments the output salinity from the miniature capacitive deionization device can be adjusted by changing a set point on the controller. This can be helpful to reduce the operating cost of this system. A new output salinity may result in changes to the flowrate of the system and/or the set point of the control valve directing treated water to enter the clean tank/pipe. By monitoring the conductivity of the outlet water, the controller can calculate the average salinity of the treated water, thereby controlling the salinity.

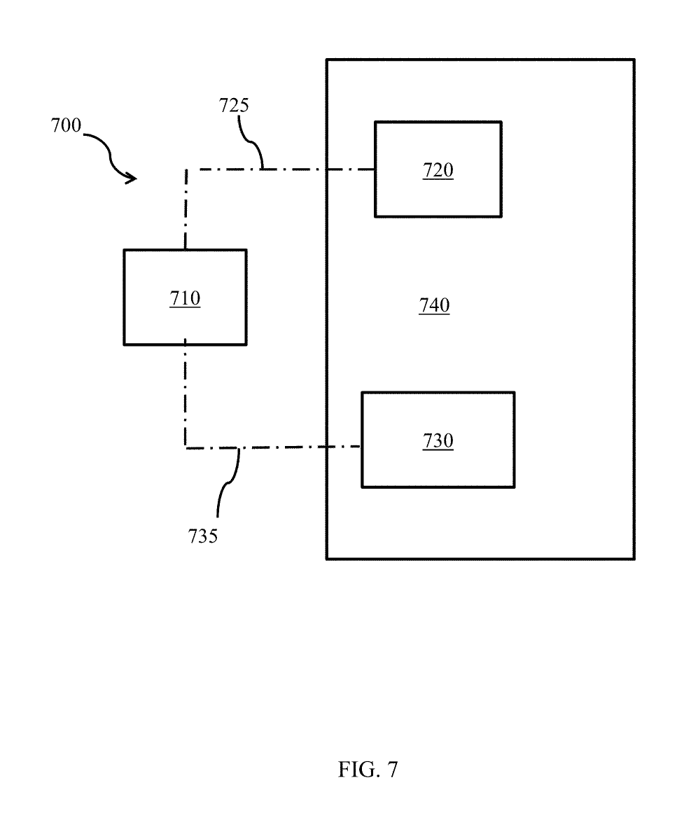

For example, FIG. 7 shows a representative control system 700. The control system 700 comprises a controller 710, an input device 720, and an output device 730 coupled together. The controller 710 may receive an input signal 725 from the input device 720 corresponding to a measurement taken by the input device 720. In response to the input signal 725, the controller 710 may deliver an output signal 735 to the output device 730 directing the operation of the output device. In FIG. 7, a deionization device 740 is coupled to the controller 710, so that the controller 710 aids in operations related to the system 740.

The input device 720 may comprise a sensor or monitor. The input device may comprise a sensor configured to monitor a parameter of the system 740. The input device 720 may be placed within or in proximity to the system 740. For example, the input device 720 may comprise an conductivity measurement instrument calibrated to indicate the salinity level within the system. The input device may regularly or continuously transmit the level value to the controller via the input signal 725.

The output device 730 may comprise a device that affects a system parameter. For example, the output device 730 may comprise a pump in fluidic communication with system components. The output device may be controlled by the controller 710 via output signal 735.

According to some embodiments, the controller comprises a PID controller that operates according to a proportional-integral-derivative control loop. However, other control loop feedback mechanisms may be used, as would be understood by a person of ordinary skill in the art.

In some embodiments, an input sensor may comprise a sensor monitoring the inlet conductivity of feed water to the miniature capacitive deionization device. By monitoring inlet conductivity, the miniature capacitive deionization device can optimize performance by adjusting outlet conductivity, energy usage, flowrate, uptime, etc.

In some embodiments, an input sensor may comprise sensors monitoring the inlet and outlet conductivity of water from the miniature capacitive deionization device and water demand of other system components. By monitoring these, the miniature capacitive deionization device can optimize performance by adjusting outlet conductivity, energy usage, flowrate, uptime, etc.

In some embodiments, operating in a “feed and bleed” configuration, like that described with regard to FIG. 9, the conductivity of water in the reservoir is monitored and used to control how long water is recycled through a capacitive deionization device. In some embodiments, current to the capacitive deionization device is monitored and when it falls below a set point, indicating that the capacitors are approaching capacity for ionic adsorption, the device then switches into the brine reject mode to restore the capacitors.

In some embodiments, change from treatment mode to reject mode is based on a timer control. In other words, the time duration of the clean and reject cycles are controlled by a preset timer.

In some embodiments, the miniature capacitive deionization device may be operated on constant voltage or constant current operation When the device is operated in a constant voltage mode, the amperage drops as capacitors fill with ionic species. In a constant current mode, the voltage increases as capacitors fill with ionic species. The device could also be operated in a constant power mode, where the amps and/or volts are controlled to impart a constant power to the capacitor.

By monitoring key aspects of system performance, the miniature capacitive deionization device may be shut off when needed, saving water, energy, and maintenance.

As described above, certain embodiments of the inventive systems include one or more computer implemented control systems (programmable logic controllers, or PLC's) for operating various components of the water treatment system, (e.g., controller 710 of the computer implemented control system 700 shown in FIG. 7). In general, any calculation methods, steps, simulations, algorithms, systems, and system elements described herein may be implemented and/or controlled using one or more computer implemented control system(s), such as the various embodiments of computer implemented systems described below. The methods, steps, control systems, and control system elements described herein are not limited in their implementation to any specific computer system, as many different machines may be used.

The computer implemented control system can be part of or coupled in operative association with an miniature capacitive deionization device unit and/or water processing unit of a system and/or other automated system components, and, in some embodiments, is configured and/or programmed to control and adjust operational parameters, as well as analyze and calculate values. In some embodiments, the computer implemented control system(s) can send and receive reference signals to set and/or control operating parameters of system apparatus. In other embodiments, the computer implemented system(s) can be separate from and/or remotely located with respect to the other system components.

Some embodiments of the described systems and methods disclosed herein provide a flexibility associated with an adjustable output salinity and variable inlet salinity. Unlike reverse osmosis which can only product a single output salinity, certain embodiments of the miniature capacitive deionization device systems can adjust the output salinity by simply changing a set point on a controller (e.g. a conductivity sensor and controller). This can be helpful to reduce the operating cost of this system.

Typical city water contains disinfectants and/or byproducts of disinfectants that cause membrane degradation issues for other desalination technologies such as reverse osmosis and must be removed from the water before entering the device. This is not necessary with the miniature capacitive deionization device as the species do not affect component integrity or performance.

Organisms experience cell wall rupture (cell lysis) when exposed to the level of electric field that exists within the flow channel of the miniature capacitive deionization device. The rate of destruction of organisms is a function of the operating voltage, residence time, and type of organism. Destruction rates as high as 3 log (99.9%) have been observed. This adds another layer of protection to the end user of the humidifier (or other couple device) knowing that any water contaminants will be reduced prior to being ejected into the breathable air.

Because typical feed water to a humidifier is city water, and city water has low hardness and total dissolved solids, the cleaning cycle time of the system can be very long, up to and greater than 1 hour. A typical household humidifier runs for 8-10 hours on a reservoir of feed water. If the cleaning cycle of the miniature capacitive deionization device is about 1 hour, the entire reservoir can be desalinated in one cycle and one hour. This enables the humidifier operation to be very simple to operate for the end user. Add water, turn on, and the average salinity of the water fed to the humidifier is low. Lower salinity water may increase the lifetime of the system due to avoidance of hardness buildup on system components such as heating coils.

The following examples are intended to illustrate certain embodiments of the present invention but do not exemplify the full scope of the invention.

### Example 1

A miniature spiral wound radial capacitive deionization device was manufactured according to the protocol described with regard to FIGS. 1A-1E and tested for performance. The device comprised a spiral capacitor formed from a pair of spirally wound capacitor electrodes and had a cylinder height of 5 inches, with the layers of material having dimensions of three inches by thirty inches when unwound, resulting in a surface area of active capacitor material of 0.21 m².

In a first test routine, the device was operated to produce a treated water flowrate of 600 ml/min or 2857 ml/min per m² of active material, during operation in a treatment mode. Reject water was produced at a flow rate of 40 ml/min, during operation in a reject mode. The modes of operation were cycled at 10 minutes of treatment mode followed by four minutes of reject mode. An initial 5.5 liters of feed water was introduced to the device via a peristaltic pump, and fed through an in-line conductivity and pressure sensor.

The initial feed water had an electrical conductivity of 1104 μS/cm. The treated water was recycled back to the tank and to the device again, in a feed and bleed configuration like that shown in FIG. 9. After 100 total minutes of treatment, the resulting 4 liters of treated water had a conductivity of 81 μS/cm. 1.5 liters of rejected water were produced over the testing period having a conductivity of 3540 μS/cm. The recovery rate for the process (ratio of treated water produced to total water) was 72.7%.

Table 1 shows the results at each ten minute period of treatment.

TABLE 1

| Time | EC | Volume | salt removed | Flux |
|---|---|---|---|---|
| (min) | (uS) | (liters) | (gms) | (mmole/min/m2) |
| 0 | 1104 | 5.5 | | |
| 10 | 905 | 5.5 | 0.7114 | 5.84 |
| 20 | 812 | 5.5 | 0.3325 | 2.73 |
| 30 | 718 | 5.5 | 0.3361 | 2.76 |
| 40 | 558 | 5 | 0.5200 | 4.27 |
| 50 | 376 | 5 | 0.5915 | 4.86 |
| 60 | 289 | 5 | 0.2828 | 2.32 |
| 70 | 256 | 4.75 | 0.1019 | 0.84 |
| 80 | 145 | 4.5 | 0.3247 | 2.67 |
| 90 | 123 | 4.5 | 0.0644 | 0.53 |
| 100 | 81 | 4.25 | 0.1160 | 0.95 |

In a second test routine performed using the same device, the device was operated to produce a treated water flowrate of 600 ml/min or 2857 ml/min per m² of active material, during operation in a treatment mode. Reject water was produced at a flow rate of 40 ml/min, during operation in a reject mode. The modes of operation were cycled at 16 minutes (10 minutes for the first cycle) of treatment mode followed by four minutes of reject mode. An initial volume of 5.75 liters of feed water was introduced to the device via a peristaltic pump, and fed through an in-line conductivity and pressure sensor.

The initial feed water had an electrical conductivity of 709 μS/cm. The treated water was recycled back to the tank and to the device again, in a feed and bleed configuration like that shown in FIG. 9. After 90 total minutes of treatment, the resulting 4 liters of treated water had a conductivity of 84 μS/cm. 1.8 liters of rejected water were produced over the testing period having a conductivity of 2081 μS/cm. The recovery rate for the process (ratio of treated water produced to total water) was 68.7%.

Table 2 shows the results after each period of treatment.

TABLE 2

| Time | EC | Volume | salt removed | Flux |
|---|---|---|---|---|
| (min) | (uS) | (liters) | (gms) | (mmole/min/m2) |
| 0 | 709 | 5.75 | | |
| 10 | 536 | 5.75 | 0.6466 | 5.31 |
| 26 | 413 | 5.25 | 0.4197 | 3.45 |
| 42 | 307 | 5 | 0.3445 | 2.83 |
| 58 | 212 | 4.6 | 0.2841 | 2.33 |
| 74 | 143 | 4.25 | 0.1906 | 1.56 |
| 90 | 84 | 3.95 | 0.1515 | 1.24 |

### Example 2

An experiment was performed to test a humidifier unit's ability to resist bacteria build up when a miniature radial capacitive deionization device is incorporated. The miniature spiral wound radial capacitive deionization device was manufactured according to the protocol described with regard to FIGS. 1A-1E and tested for performance. The device comprised a spiral capacitor formed of a pair of spirally wound capacitor electrodes and had a cylinder height of 5 inches, with the layers of material having dimensions of three inches by thirty inches when unwound, resulting in a surface area of active capacitor material of 0.21 m².

Two identical humidifiers were tested, one with a miniature radial capacitive deionization device operated in a “feed and bleed” configuration, like that shown in FIG. 9 and one without.

Bacteria were added to each system at 1MPN (“Most Probable Number”)/L each day for two months. In the humidifier without the miniature device bacteria grew to the extent that the bottom of the humidifier was not visible. In the humidifier with a miniature radial capacitive deionization device, no bacteria was visible after two months and the system continued to produce clear water. This experiment demonstrates the ability of the devices disclosed herein to reduce bacterial build-up.

Various of the unit operations described herein can be “directly fluidically connected” to other unit operations and/or components. Generally, a direct fluid connection exists between a first unit operation and a second unit operation (and the two unit operations are said to be “directly fluidically connected” to each other) when they are fluidically connected to each other and the composition of the fluid does not substantially change (i.e., no fluid component changes in relative abundance by more than 5% and no phase change occurs) as it is transported from the first unit operation to the second unit operation. As an illustrative example, a stream that connects first and second unit operations, and in which the pressure and temperature of the fluid is adjusted but the composition of the fluid is not altered, would be said to directly fluidically connect the first and second unit operations. If, on the other hand, a separation step is performed and/or a chemical reaction is performed that substantially alters the composition of the stream contents during passage from the first component to the second component, the stream would not be said to directly fluidically connect the first and second unit operations.

It should also be understood that, where separate units are shown in the figures and/or described as performing a sequence of certain functions, the units may also be present as a single unit (e.g., within a common housing), and the single unit may perform a combination of functions.

It should also be understood that a number of different unit operations, not shown in any of the figures, may be performed at various stages of the system either upstream or downstream of a deionization device.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively.

What is claimed is:

1. A miniature radial capacitive deionization device for use in treating an aqueous stream by capacitive deionization, comprising:
an inlet to receive an aqueous stream;
an outlet for delivering a treated aqueous stream;
one or more capacitors positioned within a housing and defining a flow path between and in fluid communication with the inlet and the outlet and configured to produce the treated aqueous stream, wherein each of the one or more capacitors comprises:
a first electrode;
a first ion specific layer associated with the first electrode;
a second electrode spaced apart from the first electrode;
a second ion specific layer associated with the second electrode; and
a dielectric spacer forming the flow path positioned between the first ion specific layer and the second ion specific layer and configured to receive a portion of the aqueous stream from the inlet and deliver a portion of the treated aqueous stream to the outlet;
wherein the total volume enclosed by the housing is between 50 and 2000 cm³; and
wherein the one or more capacitors are arranged as a spiral or with the plurality of electrodes arranged as concentric cylinders.

2. The device of claim 1, wherein the one or more capacitors are arranged in a spiral pattern.

3. The device of claim 1, wherein the one or more capacitors are arranged with the plurality of electrodes arranged as concentric cylinders.

4.-19. (canceled)

20. The device of claim 3, further comprising an inner support tube surround by an innermost capacitor pair of the one or more capacitors.

21. The device of claim 20, further comprising an electrical connection positioned, at least partially, within the inner support tube.

22. A method of treating an aqueous stream, the method comprising:
feeding water from a source of the water to a miniature radial capacitive deionization device enclosed within a housing having a volume between 50 and 2000 cm³;
treating the water within the miniature radial capacitive deionization device to produce a treated water; and
delivering the treated water to a reservoir or water processing unit.

23. The method of claim 22, wherein treating the water within the miniature radial capacitive deionization device comprises feeding the water into the miniature radial capacitive deionization device and at least partially removing at least one ionic species from the water to produce the treated water.

24. The method of claim 23, wherein the at least one ionic species at least partially removed comprises one or more of Li, Na, Ca, Mg, K, U, Hg, Se, Ba, Sr, Fe, Mn, Cr, Ni, Cu, Zn, Sn, Sb, Pb, Ag, Au, Cd, Hg, B, Bi, chlorides, sulfates, sulfides, sulfites, nitrates, phophates, carbonates, borates, silica, selenates, selanites, bromides, iodides, and alkalines.

25. The method of claim 23, wherein the at least one ionic species at least partially removed comprises at least one hardness ion.

26. The method of claim 23, wherein the at least one ionic species at least partially removed comprises sodium and chlorine, and wherein the water from the source of water is at least partially desalinated by the miniature radial capacitive deionization device.

27.-33. (canceled)

34. A humidifier system comprising:
a humidifier unit; and
a capacitive deionization device fluidically coupled with the humidifier unit.

35. The humidifier system of claim 34, wherein the humidifier unit comprises a point of use humidifier.

36.-42. (canceled)

44.-48. (canceled)

49. A method for treating a water associated with a humidifier system, the method comprising:
introducing a water stream to a capacitive deionization device;
treating the water within the capacitive deionization device to produce a treated water;
introducing the treated water to a humidifying unit; and
humidifying a local atmosphere with the treated water by generating a water vapor or water mist with the humidifying unit.

50.-56. (canceled)

57. A system comprising: a humidifier unit; and
a radial deionization unit fluidically coupled with the humidifier unit.

58. A method comprising:
operating a system comprising a humidifier unit and a radial capacitive deionization unit.

59. A method comprising:
treating a source of water in a radial capacitive deionization unit to produce a treated water;
and delivering the treated water to a humidifier unit.

60. A method comprising:
delivering a source of water to a humidifier reservoir; and
continuously treating the water through the means of recirculating the water through a radial capacitive deionization unit.

61. A method comprising:
delivering a source of water from a humidifier reservoir to a radial capacitive deionization unit;
treating the water in the radial capacitive deionization unit to produce a treated water; and
delivering the treated water to a heating or vaporization unit within a humidification device.
